(19) United States
(12) Patent Application Publication
(10) Pub. No.: US 2008/0151144 A1
(43) Pub. Date: Jun. 26, 2008

(54) LIQUID CRYSTAL DISPLAY DEVICE

(75) Inventors: Yoichi Hirose, Tokyo (JP); Tsuyoshi Kamada, Kanagawa (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: SONY CORPORATION, Tokyo (JP)

(21) Appl. No.: 11/957,892

(22) Filed: Dec. 17, 2007

(30) Foreign Application Priority Data
Dec. 26, 2006 (JP) 2006-350261

(51) Int. Cl. G02F 1/1335

(52) U.S. Cl. 349/69

(57) ABSTRACT

A liquid crystal display device is disclosed. the device includes: a light source using an organic electroluminescent device of almost white luminescence; a liquid crystal display part configured to modulate a light from the light source based on a video signal and to display an image; a chromaticity detecting part configured to detect a chromaticity of the light from the light source; and a correcting means for correcting a chromaticity of the image displayed on the liquid crystal display part, wherein the correcting unit compares the chromaticity detected in the chromaticity detecting part with a reference chromaticity, and corrects at least one video signal among red, green and blue video signals of three primary colors based on the compared result.

### CROSS REFERENCES TO RELATED APPLICATIONS

The present invention contains subject matter related to Japanese Patent Application JP 2006-350261 filed in the Japanese Patent Office on Dec. 26, 2006, the entire contents of which being incorporated herein by reference.

### BACKGROUND OF THE INVENTION

1. Field of the Invention

The present invention relates to a liquid crystal display device using an organic electroluminescent device as a backlight for a liquid crystal display panel.

2. Description of the Related Art

For a backlight for a liquid crystal panel, a cold-cathode tube (fluorescent lamp) is generally used. The cold-cathode tube is advantageous in power consumption, lifetime and costs, but the cold-cathode tube uses mercury as a material, and thus it is necessary to introduce an alternative light source device for preventing environmental pollution when discarded. Because an organic electroluminescent device (hereinafter, referred to as an organic EL device) has such characteristics that the device is driven at low voltage and has an excellent color reproducibility, in recent years, a backlight using an organic EL device is actively developed.

In a liquid crystal display device, the light emitted from a backlight is generally used as white light. Therefore, in the case in which an organic EL device with red (R), green (G), and blue (B) luminescence is used as a backlight, the lights of the individual colors are optically combined at a certain ratio, and white light of a predetermined color balance is generated and used. In addition, in recent years, a white luminescent organic EL device is implemented by dispersing R, G, and B luminescent components in an organic EL layer configuring the organic EL device, or by alternately laminating R, G, and B organic EL layers of three primary colors for light emission.

Although the backlight using the organic EL device is being improved, the backlight has problems of a greater degradation in luminance and a greater change in color balance (chromaticity shift) than the backlight using the cold-cathode tube when lit for a long time. This is because the luminance of an organic EL device emitting light is degraded over time to finish luminance lifetime, and the luminance lifetime is varied depending on R, G, and B luminescent materials, which causes a decrease in the luminance of each color over time, and causes the color balance generated by color mixture to become unbalanced from the initial settings. In the organic EL device, a blue luminescent material particularly tends to degrade.

For the counter measures against the change in color balance, for example, JP-A-2003-107473 (Patent Reference 1) describes a liquid crystal display device in which the drive current of a backlight is controlled to adjust color balance based on the luminance lifetime data of each color of an organic EL device of R, G, and B luminescence, whereby the backlight is maintained to have a desired color balance.

### SUMMARY OF THE INVENTION

In the case in which an organic EL device of R, G, and B luminescence is used as a backlight, a scheme is necessary to mix colors so as not to cause color shading in the display of the liquid crystal panel. Therefore, there is a problem that it is difficult to reduce the overall thickness and weight of the backlight and the liquid crystal display device.

On the other hand, in the case in which an organic EL device of white luminescence in monochrome is used, it is unnecessary to mix the colors of luminous lights. Thus, a further reduction in the thickness and weight of the backlight can be implemented. However, even in the white luminescent organic EL device, generally, a plurality of color luminescent materials is combined to reproduce white color, and thus, as described above, the white luminescent organic EL device has a problem that the luminance of each of color luminescent materials is changed over time and the color balance of white light is varied.

In the method of Patent Reference 1, since the organic EL device of R, G, and B luminescence is used as a backlight, the light quantity can be separately controlled for each color to adjust the color balance. However, in the white luminescent organic EL device, it is difficult to adjust changes in the color balance of white light. On this account, in the liquid crystal display device using the white luminescent organic EL device as a backlight, there is a problem that the color balance of an image displayed on the liquid crystal panel is changed in association with the change in the color balance of the backlight, and thus the observing conditions of images are varied.

Therefore, it is desirable to provide a liquid crystal display device in which images can be displayed in a stable color balance with no changes in the color balance of images displayed on a liquid crystal panel, in a liquid crystal display device using an organic EL device of white luminescence as a backlight.

A liquid crystal display device according to an embodiment of the invention is a liquid crystal display device including: a light source using an organic electroluminescent device of almost white luminescence; a liquid crystal display part configured to modulate a light from the light source based on a video signal and to display an image; a chromaticity detecting part configured to detect a chromaticity of the light from the light source; and a correcting means for correcting a chromaticity of the image to be displayed on the liquid crystal display part, wherein the correcting means compares the chromaticity detected in the chromaticity detecting part with a reference chromaticity, and corrects at least one video signal among red, green and blue video signals of three primary colors based on the compared result.

As described above, according to the embodiment of the invention, the chromaticity of the backlight using the organic EL device of white luminescence is detected, and the red, green, and blue video signals of the liquid crystal panel are corrected based on the result of comparing the detected value with the reference value. Thus, the color balance of the image to be displayed on the liquid crystal panel is corrected in accordance with changes in the color balance of the backlight.

According to the embodiment of the invention, in the liquid crystal display device using the white luminescent organic EL device as a backlight, the color balance of the image to be displayed on the liquid crystal panel is corrected in accordance with changes in the color balance of the backlight. Therefore, changes in the color balance of an image displayed on the liquid crystal panel can be suppressed, and an image in a stable color balance can be displayed.

### BRIEF DESCRIPTION OF THE DRAWINGS

FIG. 1 shows a cross section depicting an exemplary configuration of a liquid crystal display device according to a first embodiment of the invention;

FIG. 2 shows a schematic diagram depicting an exemplary configuration in which the luminance and chromaticity of the liquid crystal display device are corrected;

FIG. 3 shows a schematic diagram depicting another exemplary configuration in which the luminance and chromaticity of the liquid crystal display device are corrected;

FIG. 4 shows a block diagram depicting an exemplary configuration of a luminance and chromaticity correction circuit of the liquid crystal display device;

FIG. 5 shows a graph depicting the relation between the input signal and the output signal when an LUT is used; and

FIG. 6 shows a perspective view depicting an exemplary tiling backlight according to a second embodiment of the invention.

### DETAILED DESCRIPTION OF THE INVENTION

Hereinafter, embodiments of the invention will be described with reference to the drawings. Moreover, in all of the drawings in the embodiments below, the same or the corresponding portions are designated with the same numerals and signs.

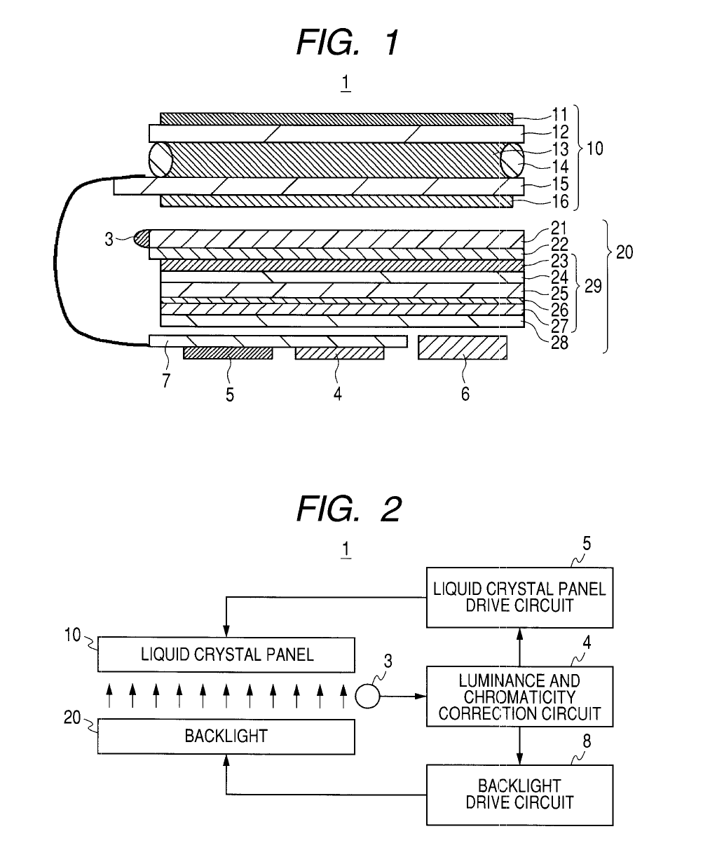

FIG. 1 shows a cross section depicting an exemplary configuration of a liquid crystal display device according to an embodiment of the invention. A liquid crystal display device 1 mainly has a transmissive liquid crystal panel 10 that displays images, a backlight 20 that is a light source, a photosensor 3 that detects components of light emitted from the backlight 20, an IC (Integrated Circuit) that includes a luminance and chromaticity correction circuit 4 and a liquid crystal panel drive circuit 5 provided on a substrate 7, and a power supply part 6 that drives the backlight 20. Moreover, in FIG. 1, connections between the backlight 20, the power supply part 6 and the substrate 7 are omitted in the drawing for simplicity.

For example, the liquid crystal panel 10 is an active matrix liquid crystal panel having a liquid crystal layer 13 that is formed in which a liquid crystal material is sandwiched between a color filter substrate 12 and a thin film transistor array substrate 15 and the outer parts thereof are air-tightly sealed with a sealing material 14, and further having a front polarizer 11 and a back polarizer 16 provided on the outer side surfaces of the color filter substrate 12 and the thin film transistor array substrate 15, respectively. On the thin film transistor array substrate 15, a plurality of gate bus lines and source bus lines insulated to each other is formed in a matrix, and at each of the intersection points thereof, a pixel electrode is formed through a switching device such as a thin film transistor (hereinafter, properly referred to as TFT). In addition, on the color filter substrate 12, a counter electrode is provided that drives liquid crystals together with the pixel electrode.

The gate bus line and the source bus line are electrically connected to the liquid crystal panel drive circuit 5 through a connecting terminal for mounting. For example, the liquid crystal panel drive circuit 5 is provided on the substrate 7 by a mounting method called TAB (tape automated bonding). For example, for the substrate 7, a flexible printed circuit (FPC) is used having polyimide as a base material.

The liquid crystal panel drive circuit 5 is mainly configured of a power supply circuit that generates various voltages based on a reference voltage, a liquid crystal controller that processes digital video signals externally inputted as differential signals, a source driver that outputs video signals based on an instruction from the liquid crystal controller, and a gate driver that outputs a scan pulse based on an instruction from the liquid crystal controller. In addition, the liquid crystal panel drive circuit 5 may be provided with a timer functionality that operates the luminance and chromaticity correction circuit 4, described later.

The gate driver generates a control signal that turns on or off the switching device, and supplies the signal to the gate bus line, based on a gate-on signal generated from a gate-on voltage generating part in synchronization with a gate drive timing signal supplied at a timing of 60 Hz, for example. The gate driver performs the gate scan operation in which about 200 gate bus lines, for instance, are in turn horizontally scanned, and the driver lights a desired pixel electrode through the switching device.

In the liquid crystal panel 10, the switching device selected by the control signal supplied from the gate driver is turned on or off to control lighting the pixel electrode, and then the video signal supplied from the source driver to the source bus line is displayed. Then, based on the potential difference between a pixel electrode voltage and a counter voltage applied to the counter electrode, liquid crystal materials respond and are driven at a predetermined transmittance. Then, the potential difference is maintained until a scan is done in the subsequent frame time, whereby an image is displayed on the liquid crystal panel 10.

In addition, in the liquid crystal panel 10, color display is implemented in which white light emitted from the backlight 20 is transmitted through the color filter 12 on which three primary colors, red (R), green (G), blue (B), are arranged with respect to each of the pixels.

The backlight 20 functions as a light source that emits white light to display an image on the liquid crystal panel 10. The backlight 20 is a direct backlight that illuminates the liquid crystal panel 10 from right under the back side, and is an area lit configuration backlight in which a light emitting part is formed in a sheet shape.

For the backlight 20, such an organic EL device of almost white luminescence is used. The backlight 20 is configured in which an anode 22, an organic layer 29, and a cathode 28 are in turn laminated on one surface of a flat transparent substrate 21 with a high optical transparency. For example, for the transparent substrate 21, a glass or plastic substrate having a thickness of about 0.6 mm to 1.1 mm is used.

The anode 22 is an electrode that injects holes into a hole injection layer 23, for which an electrode material with a great work function is used. In addition, because of the necessity of taking out the light emitted from the organic EL device, a transparent electrode is generally used for the anode. For example, indium tin oxide (ITO) is used as an electrode material.

On the other hand, the cathode 28 is an electrode that injects electrons, and for example, an electrode material with a small work function such as magnesium is used. The cathode 28 may be provided with an opening in a predetermined size for arranging the photosensor 3.

For example, the organic layer 29 is formed in a five layer structure of the hole injection layer 23, a hole transport layer 24, an organic light emitting layer 25, an electron transport layer 26, and an electron injection layer 27. The hole injection layer 23 is a layer that receives holes injected from the anode 22 and transports them to the hole transport layer 24. In addition, the hole transport layer 24 is a layer that transports the holes from the hole injection layer 23 to the organic light emitting layer 25. On the other hand, the electron injection layer 27 is a layer that receives electrons injected from the cathode 28 and transports them to the electron transport layer 26. In addition, the electron transport layer 26 is a layer that transports the electrons from the electron injection layer 27 to the organic light emitting layer 25. The organic light emitting layer 25 is a layer in which the holes are recombined with the electrons to emit light. For example, the organic light emitting layer 25 is formed by laminating a plurality of thin film color luminescent materials that emit red (R), green (G), and blue (B) lights in layers, and the organic light emitting layer 25 can be designed to have the ratio of the color luminescent materials so that luminous lights are taken out of the transparent substrate 21 to mix the luminous lights for emitting white light showing a desired chromaticity value.

The material used for the organic layer 29 is not restricted particularly as long as the material is organic compounds usable as an organic material for a luminescent material, an injection layer and a transport layer. For example, as these organic compounds, for the hole transport layer 24 and the electron transport layer 26, such compounds are named as distyrylbiphenyl luminescent materials, and amorphous aluminum luminescent materials. In addition, the organic layer 29 is not restricted to the five layer structure, which may have any layer structures in which holes are recombined with electrons in the organic light emitting layer 25 to emit light in white color.

The backlight 20 is driven by applying a voltage of about 5 to 20 V, for example, between the anode 22 and the cathode 28 from the power supply part 6. The power supply part 6 is a direct power source, for which a stabilizing control power source is used to maintain a desired set voltage. Moreover, the desired set voltage is controlled by the backlight drive circuit 8, described later. A voltage is applied to the backlight 20, and then the holes injected from the anode 22 side to the hole injection layer 23 are transported to the organic light emitting layer 25 by the hole transport layer 24, as well as the electrons injected from the cathode 28 side to the electron injection layer 27 are transported to the organic light emitting layer 25 by the electron transport layer 26. In the organic light emitting layer 25, the holes are recombined with the electrons into the excited state, and fluorescence is emitted when the state of the electrons of organic molecules is shifted from the excited state to the ground state. The light generated in the organic light emitting layer 25 is taken out of the transparent substrate 21 to outside, and white light is applied to the back side of the liquid crystal panel 10.

The chromaticity and luminance of white light emitted from the backlight 20 are detected by a luminance and chromaticity detecting part formed of the photosensor 3, an A/D converter that converts an output signal of the photosensor 3 into a digital signal, and a computing part that computes an output signal of the A/D converter. The photosensor 3 is arranged at the position at which the luminous light of the backlight 20 is received. For instance, the photosensor is arranged by contacting the light receiving part with the end part of the transparent substrate 21. For the photosensor 3, such a photosensor is used that has a light receiving diameter of about 0.5 mm to 1.0 mm, for example. As described above, the photosensor 3 is provided on the end part of the backlight 20, whereby the thickness of the liquid crystal display device 1 can be more reduced than the case in which the photosensor 3 is provided between the liquid crystal panel 10 and the backlight 20, and the light emitted from the backlight 20 can be applied to the liquid crystal panel 10 without being blocked by the photosensor 3. Moreover, the position at which the photosensor 3 is provided is not restricted to the end part of the backlight 20. For example, the photosensor 3 may be arranged in such a way that an opening is provided in the cathode 28 of the backlight 20 and the photosensor 3 is arranged inside the opening. In addition, the photosensor 3 may be a single photosensor that can detect both the luminance and the chromaticity, or photosensors may be provided separately as a chromaticity detecting part that measures the chromaticity and as a luminance detecting part that measures the luminance.

In the backlight 20, the chromaticity and the luminance are changed over time depending on the differences in the luminance lifetime of a plurality of color luminescent materials used for the organic EL device. Consequently, the color balance and luminance of images displayed on the liquid crystal panel 10 become unbalance from ones at the initial settings.

Then, in a first embodiment of the invention, the chromaticity of an image displayed on the liquid crystal panel 10 is corrected depending on the chromaticity of the backlight 20 detected by the luminance and chromaticity detecting part including the photosensor 3. In addition, the luminance of the backlight 20 is adjusted depending on the luminance of the backlight 20 detected by the luminance and chromaticity detecting part. Hereinafter, the correction of the luminance and chromaticity of the liquid crystal display device 1 will be described with reference to FIG. 2.

As shown in FIG. 2, the chromaticity and luminance of white light emitted from the backlight 20 shown by arrows are detected by the luminance and chromaticity detecting part including the photosensor 3, and the detected chromaticity value and the luminance value are supplied to the luminance and chromaticity correction circuit 4.

The luminance and chromaticity correction circuit 4 compares the current luminance value and chromaticity value of the backlight 20 detected by the photosensor 3 with the reference luminance value and the reference chromaticity value when set, and determines the differences. Moreover, the luminance value and the chromaticity value when set are values at the time when the backlight 20 is adjusted to have a desired color balance, and the values may be ones when initial settings or ones set at a given time.

As the result of the comparison, in the case in which a difference exists between the chromaticity values, it is decided that the color balance of the backlight 20 is shifted from the initial color balance, a chromaticity correction value is determined for adjusting the chromaticity of an image displayed on the liquid crystal panel. For example, the chromaticity correction value is a value that corrects at least one of R, G, and B video signals externally inputted, and the value is determined depending on the change in the color balance of the backlight 20.

The determined chromaticity correction value is supplied to the liquid crystal panel drive circuit 5. The liquid crystal panel drive circuit 5 corrects the video signal externally inputted based on the chromaticity correction value, and supplies the video signal after corrected to the liquid crystal panel 10. The liquid crystal panel 10 displays an image based on the video signal after corrected. More specifically, since the external video signal is corrected in accordance with the chromaticity change in the backlight 20, the voltage value applied to each of R, G, and B pixels of the liquid crystal panel 10 is corrected in accordance with the chromaticity change in the backlight 20, and then the color balance of the liquid crystal panel 10 is adjusted. Therefore, even though the color balance of the backlight 20 is changed, the display in a stable color balance can be maintained in the liquid crystal panel 10.

In addition, in the case in which it is detected that a difference exists between the luminance values in the luminance and chromaticity correction circuit 4, it is decided that the luminance of the backlight 20 is shifted from the initial luminance, and then a luminance correction value for adjusting the luminance of the backlight 20 is computed. The luminance correction value is a value that adjusts the luminance value of the backlight 20 to be kept almost constant, and the value is determined in accordance with the change in the luminance of the backlight 20.

The determined luminance correction value is supplied to the backlight drive circuit 8. The backlight drive circuit 8 adjusts the voltage value outputted from the power supply part 6 based on the supplied luminance correction value, and outputs the stabilized voltage to the backlight 20. The emission luminance of the backlight 20 is proportional to the product of the power supply voltage and the current. Since the emission luminance is proportional to the power supply voltage in the case in which the electric resistance of the organic EL device configuring the backlight 20 is considered to be almost constant, the power supply voltage is adjusted to control the emission luminance. More specifically, a stable luminance can be maintained in the backlight 20 by feedback control to adjust the power supply voltage in accordance with the change in the luminance of the backlight 20.

For example, the adjustment of the chromaticity and the luminance like this can be performed on a regular basis in which a timer functionality is provided to the liquid crystal panel drive circuit 5 and the luminance and chromaticity correction circuit 4 is operated in accordance with a time period from the gate-on signal that drives the gate. In addition, the adjustment may be conducted at every time when the power source of the liquid crystal display device 1 is turned on.

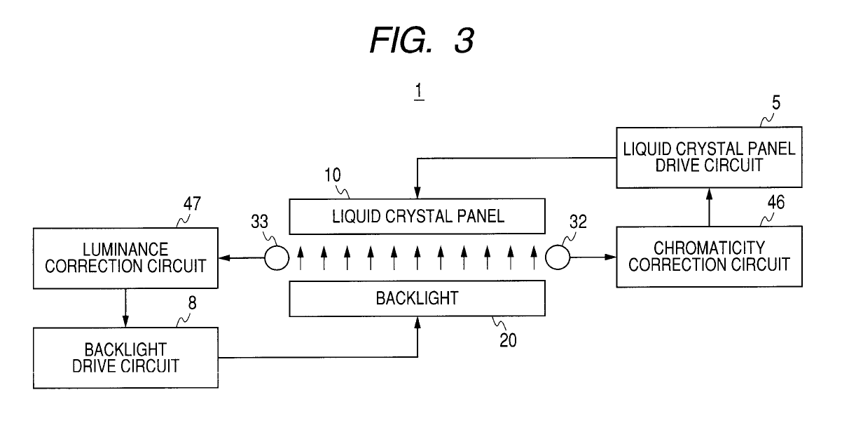

FIG. 3 shows a modification of adjusting the luminance and chromaticity of the liquid crystal display device 1. In FIG. 3, for the backlight 20, a chromaticity detection photosensor 32 that detects the chromaticity thereof, and a luminance detection photosensor 33 that detects the luminance thereof are provided separately.

A chromaticity value detected in the chromaticity detection photosensor 32 is supplied to a chromaticity correction circuit 46, and a chromaticity correction value is computed in the chromaticity correction circuit 46. Moreover, the chromaticity correction value is determined by the method similar to the method used in the luminance and chromaticity correction circuit 4, and the value is supplied to the liquid crystal panel drive circuit 5.

On the other hand, a luminance value detected in the luminance detection photosensor 33 is supplied to a luminance correction circuit 47, and a luminance correction value is determined in the luminance correction circuit 47. Similarly to the chromaticity correction value, the luminance correction value is determined by the method similar to the method used in the luminance and chromaticity correction circuit 4, and the value is supplied to the backlight drive circuit 8. The chromaticity correction of the liquid crystal panel 10 and the luminance correction of the backlight 20 based on the chromaticity correction value and the luminance correction value are the same as the corrections discussed in FIG. 2, omitting the descriptions.

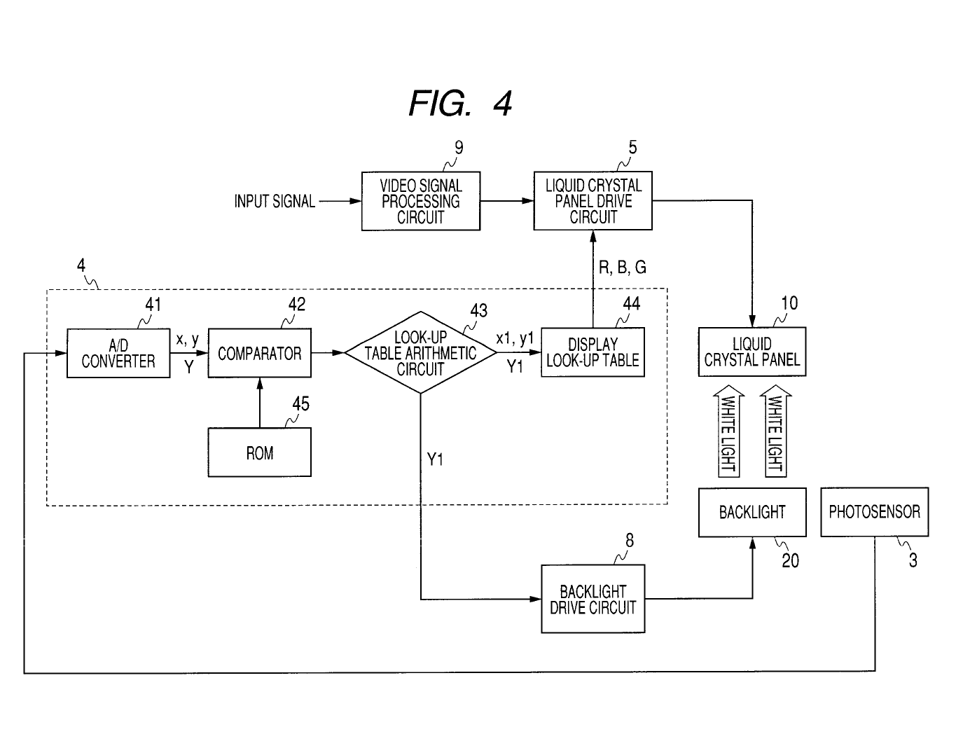

Next, the configuration and the correction method of the luminance and chromaticity correction circuit 4 will be described specifically with reference to FIG. 4. As shown in FIG. 4, the luminance and chromaticity correction circuit 4 has an A/D converter 41, a comparator 42, a look-up table arithmetic circuit 43 (hereinafter, referred to as a LUT arithmetic circuit 43), a display look-up table 44 (hereinafter, referred to as a display LUT 44), and a ROM (Read Only Memory) 45.

The photosensor 3 detects R, G, and B light components of white light emitted from the backlight 20 as color matching functions x (λ), y (λ), and z (λ) by transmitting the components through an optical filter, for example. λ (nm) is a visible light wavelength. The color matching functions x (λ), y (λ), and z (λ) are converted into tristimulus values X, Y and Z by Equations 1 to 3 below, and the values are sent as the voltage values corresponding to each of the received light quantities to the A/D converter 41. Moreover, the color matching functions x (λ), y (λ), and z (λ) are spectral characteristics defined by CIE (Commission International de Eclairage) 1931 color matching functions, and the tristimulus values X, Y and Z are three primary colors defined by CIE. In addition, in Equations 1 to 3, T (λ) is a weight function in accordance with a transmittance or a reflectance.

$$\begin{matrix}X = {\int }_{λ = 380}^{λ = 780} T ( λ ) x ( λ ) d λ & ( Equation 1 ) \\ Y = {\int }_{λ = 380}^{λ = 780} T ( λ ) y ( λ ) d λ & ( Equation 2 ) \\ Z = {\int }_{λ = 380}^{λ = 780} T ( λ ) z ( λ ) d λ & ( Equation 3 )\end{matrix}$$

The computing part provided in the A/D converter 41 computes chromaticity values (x, y) and a luminance value Y from the tristimulus values X, Y and Z supplied from the photosensor 3 by Equations 4 and 5 below, and converts them into digital values. The computed result is supplied as current chromaticity values (x, y) and a current luminance value Y to the comparator 42.

$$\begin{matrix}x = \frac{X}{X + Y + Z} & ( Equation 4 ) \\ y = \frac{Y}{X + Y + Z} & ( Equation 5 )\end{matrix}$$

The ROM 45 stores data therein that is the references of the chromaticity value and the luminance value of the backlight 20. For example, the reference data is values of set chromaticity values (x0, y0) and a set luminance value Y0 when the backlight 20 is set to have a desired chromaticity and luminance.

The comparator 42 reads the set chromaticity values (x0, y0) and the set luminance value Y0 that are reference data out of the ROM 45, and compares the values with the current chromaticity values (x, y) and the current luminance value Y supplied from the A/D converter 41 for computing the differences between the values. The computed result is supplied to the LUT arithmetic circuit 43.

In the LUT arithmetic circuit 43, based on the result in the comparator 42, chromaticity correction values (x1, y1) and a luminance correction value Y1 are determined to write new data in the display LUT 44. Then, for example, the value R for the display LUT 44 is changed based on the value x1. In addition, for example, the value B for the display LUT 44 is changed based on the value y1, and the value G for the display LUT 44 is changed based on the value Y1. Thus, the values in the display LUT 44 are rewritten.

The display LUT 44 stores correction data therein that corrects the external video signal in accordance with the change in the chromaticity of the backlight 20. For example, the correction data is data that corrects R, G, and B gray scale signals externally inputted as video signals and outputs them to the liquid crystal panel 10. In the display LUT 44, the LUT arithmetic circuit 43 rewrites correction data based on the determined chromaticity correction values (x1, y1) and the luminance correction value Y1. The rewritten correction data is held until the LUT arithmetic circuit 43 rewrites the data next time, and the video signal corrected with reference to the held data is outputted to the liquid crystal panel 10 to adjust the color tone of the liquid crystal panel 10. In addition, γ correction may be performed for the external video signal as matched with the emission characteristics of the panel 10 by referring to the display LUT 44. For example, the display LUT 44 like this is configured of an EEPROM (electrically erasable and programmable read only memory) that can electrically delete and write data.

The chromaticity correction of the liquid crystal panel 10 using the display LUT 44 will be described below. First, in the video signal processing circuit 9, R, G, and B input signals externally inputted are converted into digital signals of luminance gray scale level from 0 gray scale level to 248 gray scale levels, for example. The converted video signals are supplied to the liquid crystal panel drive circuit 5.

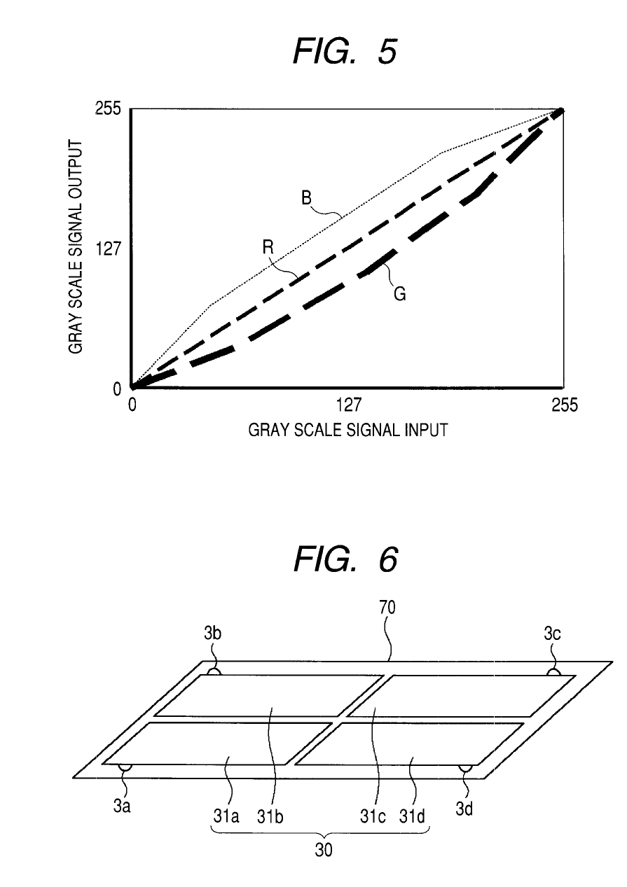

The liquid crystal panel drive circuit 5 corrects the supplied R, G, and B video signals with reference to the display LUT 44. For example, as shown in FIG. 5, by the correction using the display LUT 44, the gray scale of the external input signals is corrected to the gray scale of the output signals to the liquid crystal pane 110. Since the B luminescent material tends to particularly degrade in the organic EL device, in the example shown in FIG. 5, correction is made so as to increase the luminance gray scale level of the B input signal, whereby a decrease in the B luminance can be suppressed in an image displayed on the liquid crystal panel 10. In addition, correction is made so as to decrease the luminance gray scale level of the G input signal, the ratio of R, G, and B color balance can be adjusted to a proper one in an image displayed on the liquid crystal panel 10. The video signals thus corrected are supplied to the liquid crystal panel 10.

The liquid crystal panel 10 displays an image based on the corrected video signals. As described above, since the corrected video signals are adjusted in the ratio of R, G, and B color balance in accordance with the change in the color balance of the backlight 20, the voltage applied to each of the R, G, and B pixels of the liquid crystal panel 10 is corrected, and the color balance of the image to be displayed is corrected. More specifically, even though the chromaticity of the backlight 20 is changed, a proper color balance can be maintained in the display of the liquid crystal panel 10.

Next, again referring to FIG. 4, the luminance correction of the backlight 20 will be described. As described above, the backlight drive circuit 8 corrects the voltage value to be supplied to the backlight 20 based on the luminance correction value Y1 determined in the LUT arithmetic circuit 43. For example, in the case in which the current luminance value Y of the backlight 20 is smaller than the set luminance value Y0, the backlight drive circuit 8 functions to increase the voltage value to be supplied to the backlight 20. Thus, the backlight 20 can be maintained to have a nearly constant luminance.

As described above, in the embodiment according to the invention, in the case in which the color balance of the backlight 20 of white luminescence is out of balance, the color balance of an image displayed on the liquid crystal panel 10 is correspondingly adjusted, whereby the color balance of the liquid crystal display device 1 can be maintained in a preset color balance, or the color balance close thereto. Therefore, even though the color balance of the organic EL backlight 20 of white luminescence is changed with the use of the liquid crystal display device, the liquid crystal panel can display images in a stable color balance. In addition, in the case in which the luminance of the backlight 20 is changed, the drive voltage of the backlight 20 is corrected by feedback control, and the luminance of the backlight 20 can be maintained in a preset luminance, or the luminance close thereto. Therefore, changes in the luminance of the backlight 20 with the use of the liquid crystal display device can be suppressed.

Next, a second embodiment of the invention will be described. The second embodiment of the invention is the same as the first embodiment of the invention except the configuration of a backlight 30, omitting the descriptions of the configuration except the configuration of the backlight 30. Hereinafter, the configuration of the backlight 30 according to the second embodiment will be described.

As shown in FIG. 6, the backlight 30 according to the second embodiment is a tiling backlight 30 that is configured in which on one surface of a substrate 70, a plurality of unit backlights 31a, 31b, 31c and 31d (hereinafter, in the case in which it is unnecessary to distinguish the unit backlights from each other, properly referred to as a unit backlight 31) having an area smaller than that of the liquid crystal panel 10 is arranged flat as close to each other. The unit backlight 31 is configured of the white luminescent organic EL device similar to the backlight 20 according to the first embodiment. The unit backlights 31 are thus tiled, whereby the backlight 30 can be easily increased in size.

At the end parts of the unit backlights 31, photosensors 3a, 3b, 3c and 3d (hereinafter, in the case in which it is unnecessary to distinguish the photosensors from each other, properly referred to as a photosensor 3) are provided, respectively, which detect the luminance and chromaticity of the unit backlight 31.

On the surface of the substrate 70 on which the unit backlights 31 are not arranged, a plurality of backlight drive circuits 8 (not shown) and luminance and chromaticity correction circuits 4 (not shown) is provided, as corresponding to each of the unit backlights 31a, 31b, 31c and 31d. More specifically, since each of the unit backlights 31 has the backlight drive circuit 8 and the luminance and chromaticity correction circuit 4, the luminance and the chromaticity can be corrected for each of the unit backlights 31. Moreover, for the substrate 70, a single substrate may be used, or a plurality of substrates may be used.

In addition, a liquid crystal panel 10, not shown, has a liquid crystal panel drive circuit 5 for each of areas of the liquid crystal panel 10 split on the borders corresponding to the seams of the tiles of the unit backlights 31. Thus, for example, in the case in which the chromaticity of the unit backlight 31a is changed, the chromaticity of the area corresponding only to the unit backlight 31a can be adjusted in the liquid crystal panel 10. Therefore, in accordance with the chromaticity change in the individual unit backlights 31, the color balance of an image displayed on the liquid crystal panel 10 can be adjusted for each area.

In the configuration in which the unit backlights 31 using the white luminescent organic EL device are tiled in multiple numbers as the second embodiment, variations in the initial characteristics and changes in the chromaticity and the luminance occur in each of the unit backlights 31, and thus fluctuations tend to occur in the chromaticity and the luminance in the backlight 30 overall. According to the second embodiment of the invention, in accordance with the variations and changes in the chromaticity of each of the unit backlights 31 in the unit of the unit backlight 31, the color balance of an image displayed on the liquid crystal panel can be adjusted for each area. Therefore, the display of a liquid crystal panel with no chromaticity fluctuations can be implemented. In addition, in accordance with the variations and changes in the luminance of each of the unit backlights 31, the luminance of the unit backlight 31 can be adjusted separately, and thus the display of the liquid crystal panel 10 with no luminance fluctuations can be implemented.

As discussed above, the first and second embodiments of the invention have been described specifically, but the invention is not restricted to the first and second embodiments described above, and various modifications are possible based on the technical ideas according to the embodiment of the invention. For example, in the first embodiment, the LUT is used for correcting the video signals in the liquid crystal panel, but images displayed on the liquid crystal panel may be corrected using the other methods.

In addition, in the first embodiment, the configuration is described in which the reference values stored in the ROM are used to compute correction values in the luminance and chromaticity correction circuit, but such a configuration may be possible in which, for example, the values of the display LUT are used to compute correction values.

It should be understood by those skilled in the art that various modifications, combinations, sub-combinations and alterations may occur depending on design requirements and other factors insofar as they are within the scope of the appended claims or the equivalents thereof.

What is claimed is:

1. A liquid crystal display device comprising:
a light source using an organic electroluminescent device of almost white luminescence;
a liquid crystal display part configured to modulate a light from the light source based on a video signal and to display an image;
a chromaticity detecting part configured to detect a chromaticity of the light from the light source; and
a correcting means for correcting a chromaticity of the image to be displayed on the liquid crystal display part,
wherein the correcting means compares the chromaticity detected in the chromaticity detecting part with a reference chromaticity, and corrects at least one video signal among red, green and blue video signals of three primary colors based on the compared result.

2. The liquid crystal display device according to claim 1, further comprising a luminance detecting part configured to detect a luminance of white light of the light source,
wherein the correcting means compares the luminance detected in the luminance detecting part with a reference luminance, and corrects the luminance of white light of the light source based on the compared result.

3. The liquid crystal display device according to claim 1,
wherein the chromaticity detecting part is disposed at an end part of the light source in the thickness direction.

4. The liquid crystal display device according to claim 1,
wherein the light source is formed in a tiling light source configuration in which a plurality of unit light sources is arranged like tiles,
the chromaticity detecting part and the correcting means are provided in each of the plurality of the unit light sources, and
the correcting means corrects the chromaticity of the image for each of areas of the liquid crystal display part facing the unit light source.

5. A liquid crystal display device comprising:
a light source using an organic electroluminescent device of almost white luminescence;
a liquid crystal display part configured to modulate a light from the light source based on a video signal and to display an image;
a chromaticity detecting part configured to detect a chromaticity of the light from the light source; and
a correcting unit configured to correct a chromaticity of the image displayed on the liquid crystal display part,
wherein the correcting unit compares the chromaticity detected in the chromaticity detecting part with a reference chromaticity, and corrects at least one video signal among red, green and blue video signals of three primary colors based on the compared result.
